(19) United States
(12) Patent Application Publication
(10) Pub. No.: US 2014/0297401 A1
(43) Pub. Date: Oct. 2, 2014

(54) SHAPING ALLOCATIONS IN SEARCH ADVERTISING AUCTIONS

(71) Applicant: YAHOO! INC., Sunnyvale, CA (US)

(72) Inventors: Eric BAX, Altadena, CA (US); Raghu Donamukkala, Valencia, CA (US)

(73) Assignee: Yahoo! Inc., Sunnyvale, CA (US)

(21) Appl. No.: 13/851,753

(22) Filed: Mar. 27, 2013

(51) Int. Cl. G06Q 30/02

(52) U.S. Cl. CPC G06Q 30/0275
USPC 705/14.45; 705/14.71

(57) ABSTRACT

Methods and systems are provided that include bidding techniques for use with online advertising auctions. Methods and systems are provided relating to bidding for display of an advertisement, where the allocation of serving opportunities for advertisement slots takes into account competing bids associated with advertisers. A highest bid associated with an advertiser is allocated all the serving opportunities of one of the advertisement slots. The remaining bids associated with advertisers are allocated serving opportunities between the remaining slots based on various factors, such as historical online advertising bidding and delivery information and performance metric information.

### BACKGROUND

In online advertising, an auction is often used, in which advertisers bid for allocation and serving of their online advertisements in connection with serving opportunities. For example, in search advertising, user-entered keyword queries provide an excellent signal for determining user intent and for targeting the user with an online advertisement. Resulting advertisements are often displayed (or otherwise presented) along with each other. Advertisements may be displayed in a particular order, pattern or rank, or considered to be displayed in a particular order, pattern or rank, in terms of placement on a page. Generally, higher ranked or better placed advertisements are more valuable to advertisers, since they are generally more prominently displayed to users, and they are generally associated with better performance and expected revenue generation.

### SUMMARY

Online search advertising may be sold through slot auctions. In a slot auction, bidders may be allocated different slots based on their bids, with the highest bidder awarded the most valuable slot, the second highest bidder awarded the second most valuable slot, etc. For example, if the second slot is nearly as valuable as the first slot, then there may be less competition for the first slot. As a result, the seller is likely to get less revenue.

In some embodiments, for example, to increase the gap in value between the first and second slots, the seller can partition the second slot, awarding portions of it to multiple bidders. For example, two-thirds of the second slot can be awarded to the second highest bidder and one-third to the third-highest bidder. One way to apportion is to award the second slot at random, with probabilities equal to the portions. In the example, this would mean the second slot is awarded to the second highest bidder with probability two-thirds and to the third-highest bidder with probability one-third. Another way is to apportion over multiple auctions. In the example, this would mean awarding the second slot to the second-highest bidder in two-thirds of auctions and to the third highest bidder in one third of auctions.

In some embodiments, the result of apportioning actual slots may be to create virtual slots. In the above example, what may have been an actual two-slot auction would become a virtual three-slot auction. By setting the portions of actual slots allocated to virtual slots, the seller or their representative can shape allocations so that each virtual slot is much more valuable than the virtual slot awarded to the next-lower bidder. The likely result is more competitive bidding and more revenue for the seller.

Some embodiments of the invention provide bidding techniques for use with online advertising auctions. In some embodiments, methods and systems are provided for bidding for display of an advertisement, where the allocation of serving opportunities that takes into account competing bids present upon display of the advertisement. For example, methods and systems are provided in which a primary bidder is identified as the advertiser with the highest (i.e. winning) bid and which is allocated serving opportunities in a primary advertising slot. Accordingly, the remaining non-primary (i.e. non-winning) bidders/advertisers are allocated serving opportunities in non-primary advertising slots. The term “primary advertising slot” is determined and designated by an auction operator or facilitator. In some embodiments of the invention, determining the “primary advertising slot” includes, but is not limited to, placement with respect to other advertisement slots, size, prominence, cost, value, and/or metrics such as predicted conversion rate or CTR. By definition, “non-primary advertising slots” are advertising slots other than the “primary advertising slot”.

Auction mechanisms are provided that allow more efficient operation of auctions that allow such bidding techniques, from the perspectives of the auction provider, advertisers, and the marketplace as a whole. Some embodiments of the invention provide auction mechanisms that, while new and non-obvious over existing auction systems, can yet be implemented by modification of or addition to existing Generalized Second Price (or “GSP”) auction formats and associated computer-related implementation platforms, hardware and software. Furthermore, some embodiments do not cause changes, or cause minimal changes, from the advertiser experience perspective, relative to GSP auction formats. Other auction mechanisms are provided that differ more from GSP auction formats.

Some embodiments of the invention are described relative to a known GSP auction format. In a GSP auction, in connection with a particular serving opportunity, one or more available advertising slots are filled with matching advertisement displays. Winners of the slots may be based, for example, on a bid alone, or a term including bid and one or more other factors, such as bid multiplied by an associated click through rate, which may be a determined, forecasted or estimated click through rate. Other terms, variables or constants can also be included in more complex terms. Pricing for each slot is generally determined based on the bid (or term including bid) associated with the next lower pertinent bid. So, for example, pricing for a first slot is determined based on the bid or bid term associated with the second slot, such as by setting the price at, or at a minimum amount more than, the bid or bid term associated with the second slot, etc. In some embodiments of the invention, allocation of all serving opportunities in the first slot is to the advertiser with the highest bid while serving opportunities are unbundled from the remaining advertising slots and allocated amongst the remaining advertisers with lesser bids.

### BRIEF DESCRIPTION OF THE DRAWINGS

FIG. 1 is a distributed computer system according to one embodiment of the invention;

FIG. 2 is a simplified flow diagram illustrating a method according to one embodiment of the invention;

FIG. 3 is a simplified flow diagram illustrating a method according to one embodiment of the invention;

FIG. 4 is a simplified flow diagram illustrating a method according to one embodiment of the invention;

FIG. 5 is a conceptual diagram illustrating a method according to one embodiment of the invention; and

FIG. 6 is a conceptual block diagram illustrating one embodiment of the invention.

### DETAILED DESCRIPTION

Herein, the term “advertiser” broadly includes anyone, any entity, or any automated system that acts or facilitates action on behalf of an advertiser or an advertising campaign associated with an advertiser, and the term “bidding” broadly includes both human and automated techniques. Herein, a serving opportunity or particular serving opportunity can include forecasted, future, or equivalent serving opportunities.

Some embodiments of the invention provide bidding techniques or languages for use with online advertising auctions. In some embodiments, methods and systems are provided relating to bidding for display of an advertisement, where the allocation of serving opportunities takes into account one or more competing bids to better determine the value of the serving opportunities. For example, methods and systems are provided in which bidding takes into account the effect, or perceived, anticipated, estimated or forecasted effect, on the value of display of an advertisement, of competing bids on the value of advertisement impressions in various advertisement slots.

Herein, in situations where comparisons between values yield an equality, various known methods may be used in making a determination, such as a determination as to which outcome may be most beneficial or desirable to an auction operator or facilitator.

It is to be understood that, while bidding and auction mechanisms are described herein for simplicity in connection with a bid term that includes only the bid, the invention contemplates embodiments in which more complex bid terms are utilized, including in determinations relating to exclusive or multiple advertisement display outcomes, and in determining pricing.

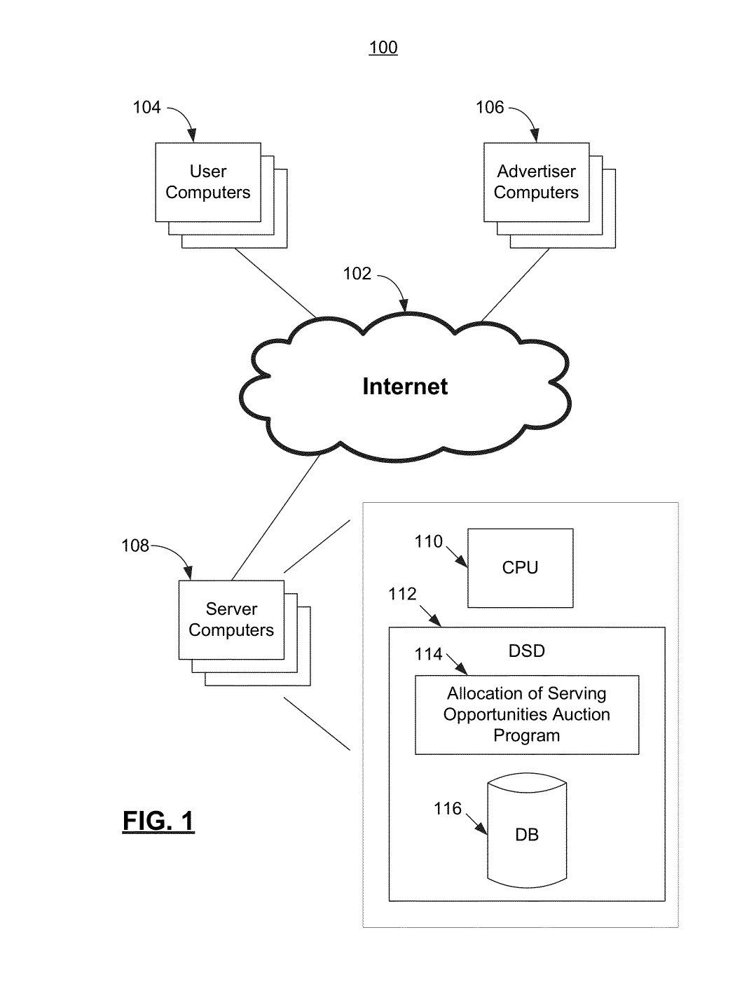

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not includes, as well as embodiments in which other networks are included in addition to the Internet, including one more wireless networks, WANs, LANs, telephone, cell phone, or other data networks, etc. The invention further contemplates embodiments in which user computers or other computers may be or include a wireless, portable, or handheld devices such as cell phones, PDAs, etc.

Each of the one or more computers 104, 106, 108 may be distributed, and can include various hardware, software, applications, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, and software to enable searching, search results, and advertising, such as graphical or banner advertising as well as keyword searching and advertising in a sponsored search context. All types of advertisements are contemplated, including textual advertisements, rich advertisements, video advertisements, etc.

As depicted, each of the server computers 108 includes one or more CPUs 110 and a data storage device 112. The data storage device 112 includes a database 116 and an Allocation of Serving Opportunities Auction Program 114.

The Allocation of Serving Opportunities Auction Program 114 is intended to broadly include all programming, applications, software and other and tools necessary to implement or facilitate methods and systems according to embodiments of the invention, whether on a single server computer or distributed among multiple computers of devices.

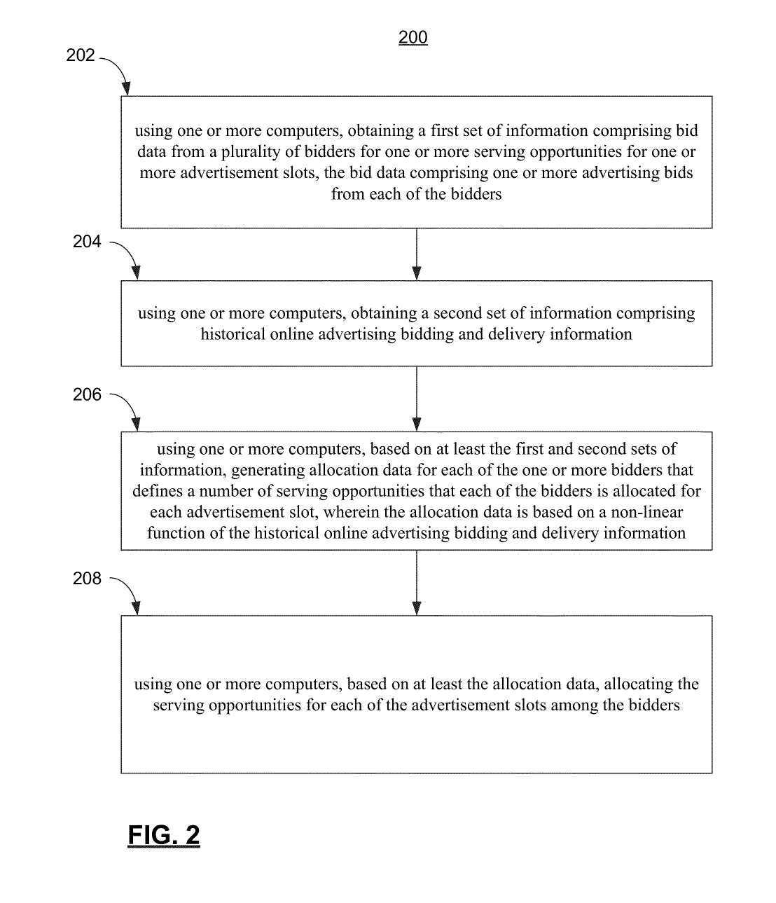

FIG. 2 is a simplified flow diagram illustrating a method 200 according to one embodiment of the invention.

At step 202, using one or more computers, a first set of information is obtained comprising bid data from a plurality of bidders for one or more serving opportunities for one or more advertisement slots. The bid data is comprised of one or more advertising bids from each of the bidders. These bids associated with advertisers are obtained for use in an online advertising auction.

At step 204, using one or more computers, a second set of information is obtained comprising historical online advertising bidding and delivery information. At step 206, using one or more computers, based on at least the first and second sets of information, allocation data is generated for display of advertisements associated with the each of the bids. The allocation data defines a number of serving opportunities that each of the bidders is allocated for each advertisement slot and is based on a non-linear function of the historical online advertising bidding and delivery information. At step 208, using one or more computers, based on at least the allocation data, the serving opportunities are allocated among the bidders for each of the advertisement slots.

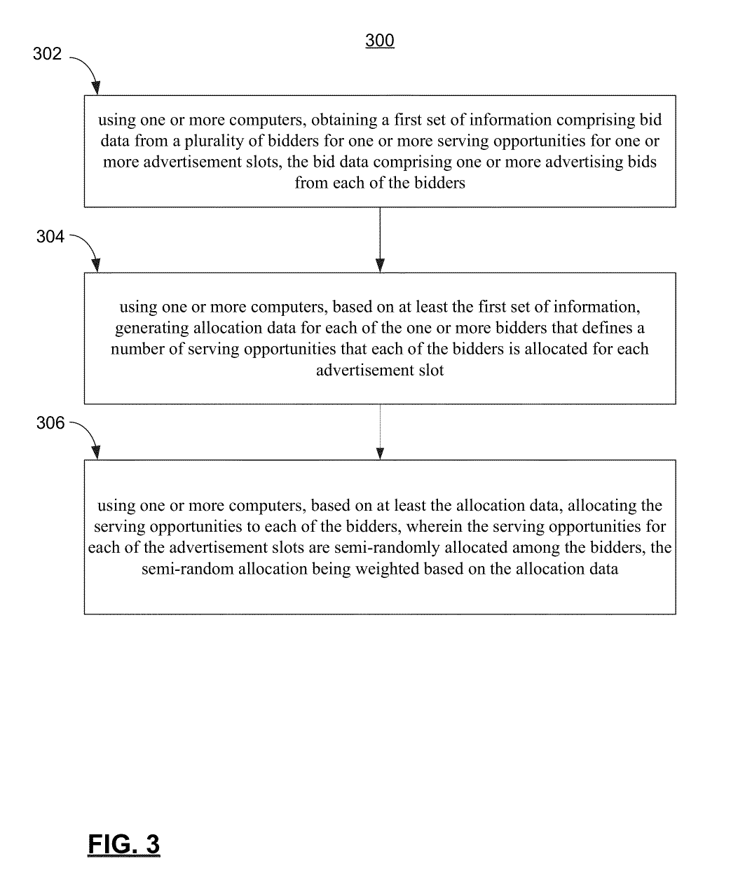

FIG. 3 is a simplified flow diagram illustrating a method 200 according to one embodiment of the invention.

At step 302, using one or more computers, a first set of information is obtained comprising bid data from a plurality of bidders for one or more serving opportunities for one or more advertisement slots. The bid data is comprised of one or more advertising bids from each of the bidders. These bids associated with advertisers are obtained for use in an online advertising auction.

At step 304, based on at least the first set of information, allocation data is generated for display of advertisements associated with the each of the bids. The allocation data defines a number of serving opportunities that each of the bidders is allocated for each advertisement slot. At step 306, using one or more computers, based on at least the allocation data, the serving opportunities are allocated among the bidders for each of the advertisement slots. The serving opportunities are semi-randomly allocated among the bidders, where the semi-random allocation is weighted based on the allocation data.

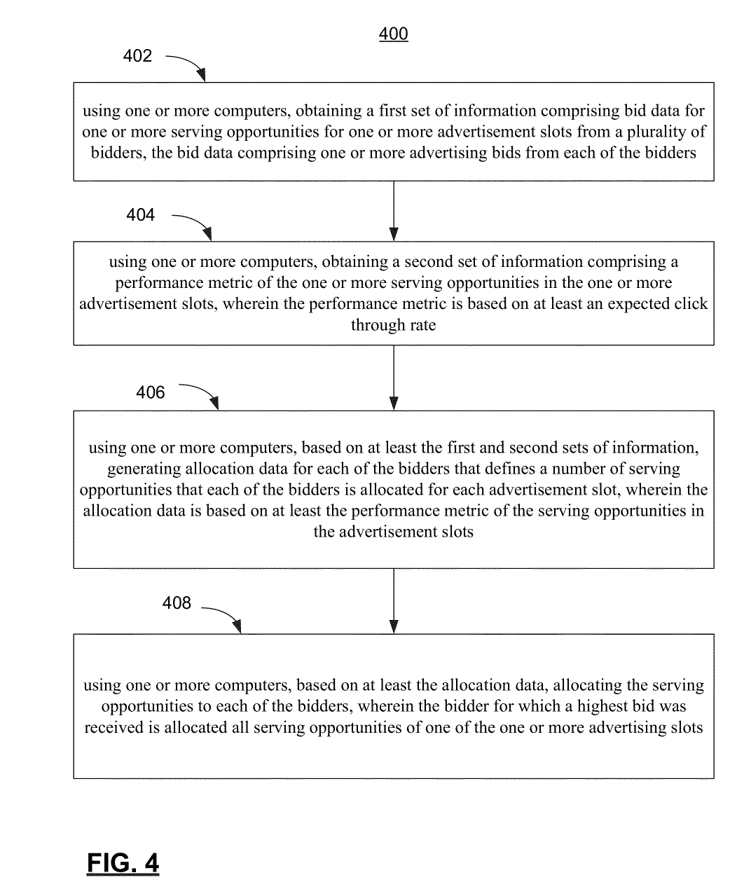

FIG. 4 is a simplified flow diagram illustrating a method 400 according to one embodiment of the invention.

At step 402, using one or more computers, a first set of information is obtained comprising bid data from a plurality of bidders for one or more serving opportunities for one or more advertisement slots. The bid data is comprised of one or more advertising bids from each of the bidders. These bids associated with advertisers are obtained for use in an online advertising auction.

At step 404, using one or more computers, a second set of information is obtained comprising a performance metric of the serving opportunities in the advertisement slots. The performance metric is based on at least an expected click through rate. At step 406, using one or more computers, based on at least the first and second sets of information, allocation data is generated for display of advertisements associated with the each of the bids. The allocation data defines a number of serving opportunities that each of the bidders is allocated for each advertisement slot and is based on at least the performance metric. At step 408, using one or more computers, based on at least the allocation data, the serving opportunities are allocated among the bidders for each of the advertisement slots. The bidder for which the highest bid was received is allocated all serving opportunities of one of the advertising slots.

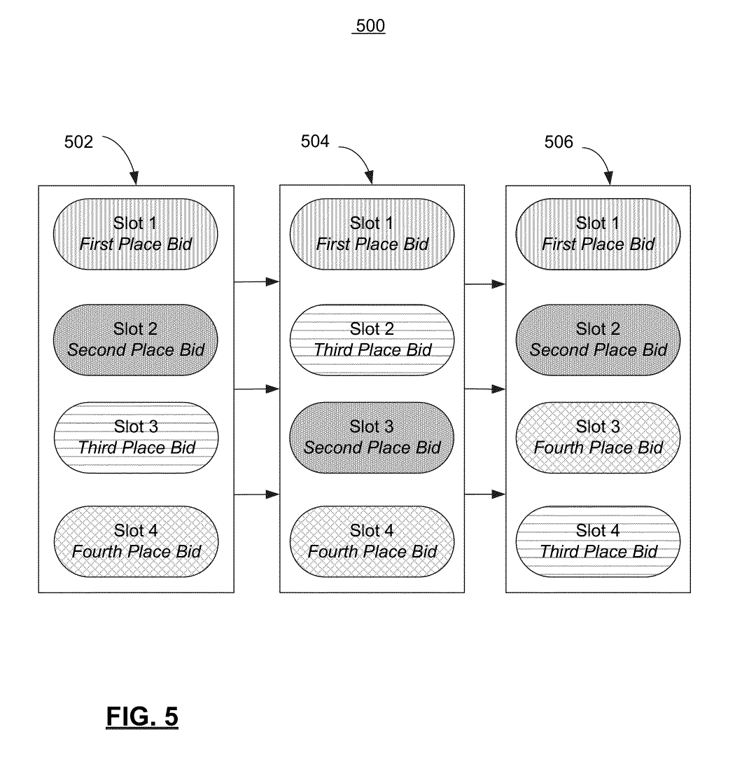

FIG. 5 is a conceptual block diagram illustrating a method 500 according to one embodiment of the invention. The diagram is simplified to illustrate the concepts underlying the claimed subject matter.

Steps 502, 504, and 506 represent three distinct and consecutive impressions, with serving opportunities for advertisements available in four advertisement slots, labeled Slot 1, Slot 2, Slot 3, and Slot 4. A first place bid, second place bid, third place bid, and fourth place bid have been received for advertising in these slots.

The first place bid, having won the online advertising auction, is allocated a serving opportunity in Slot 1 in all three impressions 502, 504, and 506.

The second place bid, third place bid, and fourth place bid are allocated various slots in each of the different impressions 502, 504, and 506. The second place bid is allocated the serving opportunity in Slot 2 in 502, in Slot 3 in 504, and in Slot 2 in 506. The third place bid is allocated the serving opportunity in Slot 3 in 502, in Slot 2 in 504, and in Slot 3 in 506. The fourth place bid is allocated the serving opportunity in Slot 4 in 502, in Slot 4 in 504, and in Slot 3 in 506.

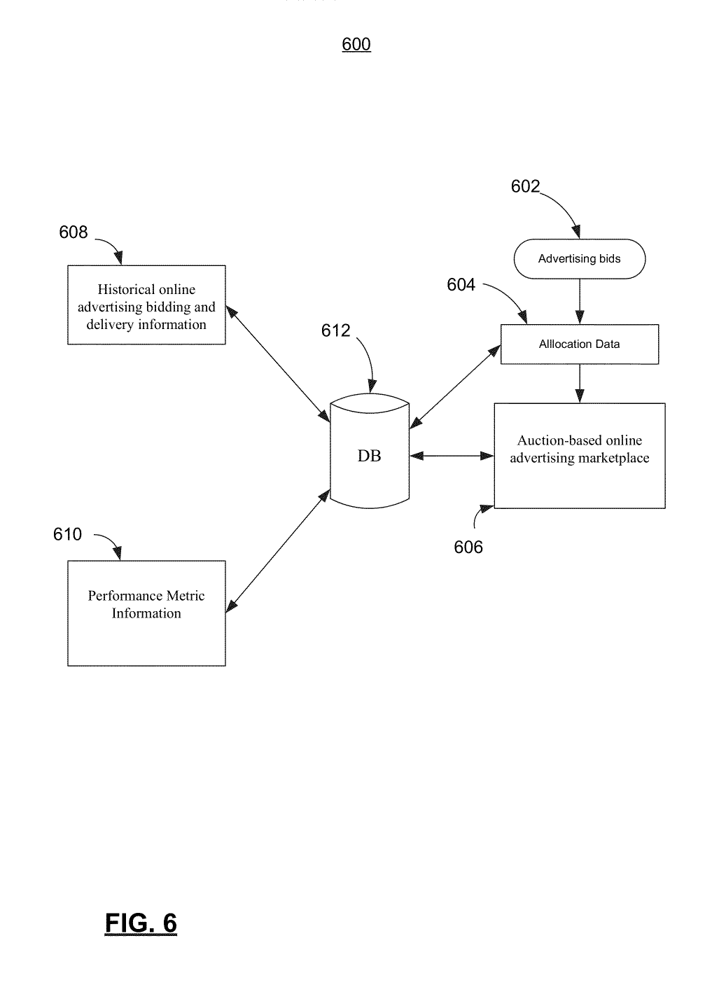

FIG. 6 is a conceptual block diagram illustrating a method 500 according to one embodiment of the invention.

Advertising bids 602 are received and used to generate allocation data 604 for the purposes of allocating serving opportunities amongst bids 602 in an auction-based online advertising marketplace 606. A database 612 is communicatively coupled to both allocation data 604 and the auction-based online advertising marketplace 606. Additionally, the database 612 is communicatively coupled to both performance metric information 610 and historical online advertising bidding and delivery information 608. Through this arrangement, the database 612 can facilitate utilizing the historical online advertising bidding and delivery information 608 and/or performance metric information 610 in determining both the allocation data 604 and/or the eventual allocation in the auction-based online advertising marketplace 606. Similarly, the database 612 can facilitate utilizing the generated allocation data 604 and conditions of the auction-based online advertising marketplace 606 to create, replenish, and/or edit both utilizing the historical online advertising bidding and delivery information 608 and/or performance metric information 610.

The foregoing description is intended merely to be illustrative, and other embodiments are contemplated within the spirit of the invention.

1. A method for use in an online advertising auction, the method comprising:
using one or more computers, obtaining a first set of information comprising bid data from a plurality of bidders for one or more serving opportunities for one or more advertisement slots, the bid data comprising one or more advertising bids from each of the bidders;
using one or more computers, based on at least the first set of information, generating allocation data for each of the one or more bidders that defines a number of serving opportunities that each of the bidders is allocated for each advertisement slot; and
using one or more computers, based on at least the allocation data, allocating the serving opportunities to each of the bidders, comprising:
identifying a primary bidder from the plurality of bidders, the primary bidder being a bidder for which a highest bid was received;
identifying a primary advertising slot from the one or more advertisement slots, wherein the primary advertising slot is comprised of one or more primary serving opportunities and is based on at least the location of the primary advertising slot with respect to one or more non-primary advertising slots;
allocating all of the primary serving opportunities in the primary advertising slot to the primary bidder; and
for a set of non-primary advertising slots, performing a non-linear allocation of one or more non-primary serving opportunities to one or more non-primary bidders, wherein the non-primary serving opportunities are allocated such that non-primary serving opportunities in each of the non-primary advertisement slots are not exclusively allocated to one of the non-primary bidders.

2. The method of claim 1, wherein the primary advertisement slot is identified based on a performance metric, wherein the performance metric is based on at least an expected click through rate.

3. The method of claim 1, wherein the primary advertisement slot is identified based on the size and cost of the advertisement slot.

4. The method of claim 1, wherein the set of non-primary advertising slots includes all the non-primary advertising slots.

5. The method of claim 1, wherein the serving opportunities for each of the advertisement slots are semi-randomly allocated among the bidders, the semi-random allocation being weighted based on the allocation data.

6. The method of claim 1, further comprising:
using one or more computers, obtaining a second set of information comprising historical online advertising bidding and delivery information; and
using one or more computers, based on at least the second set of information and the allocation data, allocating the serving opportunities for each of the advertisement slots among the bidders, wherein the allocation data is based on a non-linear function of the historical online advertising bidding and delivery information.

7. The method of claim 1, further comprising:
using one or more computers, obtaining a second set of information comprising a performance metric of the one or more serving opportunities in the one or more advertisement slots, wherein the performance metric is based on at least an expected click through rate; and
using one or more computers, based on at least the second set of information and the allocation data, allocating the serving opportunities for each of the advertisement slots among the bidders, wherein the allocation data is based on the performance metric of the serving opportunities of the advertisement slots.

8. The method of claim 1, wherein each of the one or more serving opportunities comprises one or more impressions of at least an advertisement.

9. The method of claim 8, further comprising: using one or more computers, based on at least the allocation data, facilitating display of the one or more impressions of the at least one advertisement.

10. The method of claim 1, wherein the bid data includes one or more conditions specified by each of the bidders and associated with each of the advertising bids.

11. A system comprising:
one or more server computers connected to a network; and
one or more databases connected to the one or more servers;
wherein the one or more server computers are for:
obtaining a first set of information comprising bid data from a plurality of bidders for one or more serving opportunities for one or more advertisement slots, the bid data comprising one or more advertising bids from each of the bidders;
based on at least the first set of information, generating allocation data for each of the one or more bidders that defines a number of serving opportunities that each of the bidders is allocated for each advertisement slot; and
based on at least the allocation data, allocating the serving opportunities to each of the bidders, comprising:
identifying a primary bidder from the plurality of bidders, the primary bidder being a bidder for which a highest bid was received;
identifying a primary advertising slot from the one or more advertisement slots, wherein the primary advertising slot is comprised of one or more primary serving opportunities and is based on at least the location of the slot with respect to one or more non-primary advertising slots;
allocating all of the primary serving opportunities in the primary advertising slot to the primary bidder; and
for a set of non-primary advertising slots, performing a non-linear allocation of one or more non-primary serving opportunities to one or more non-primary bidders, wherein the non-primary serving opportunities are allocated such that non-primary serving opportunities in each of the non-primary advertisement slots are not exclusively allocated to one of the non-primary bidders.

12. The system of claim 11, wherein the primary advertisement slot is identified based on a performance metric, wherein the performance metric is based on at least an expected click through rate.

13. The system of claim 11, wherein the primary advertisement slot is identified based on the size and cost of the advertisement slot.

14. The system of claim 11, wherein the set of non-primary advertising slots includes all the non-primary advertising slots.

15. The system of claim 11, wherein the serving opportunities for each of the advertisement slots are semi-randomly allocated among the bidders, the semi-random allocation being weighted based on the allocation data.

16. The system of claim 11, further comprising:
obtaining a second set of information comprising historical online advertising bidding and delivery information; and
based on at least the second set of information and the allocation data, allocating the serving opportunities for each of the advertisement slots among the bidders, wherein the allocation data is based on a non-linear function of the historical online advertising bidding and delivery information.

17. The system of claim 11, further comprising:
obtaining a second set of information comprising a performance metric of the one or more serving opportunities in the one or more advertisement slots, wherein the performance metric is based on at least an expected click through rate; and
based on at least the second set of information and the allocation data, allocating the serving opportunities for each of the advertisement slots among the bidders, wherein the allocation data is based on the performance metric of the serving opportunities in the advertisement slots.

18. The system of claim 11, wherein each of the one or more serving opportunities comprises one or more impressions of at least an advertisement.

19. The system of claim 18, further comprising: using one or more computers, based on at least the allocation data, facilitating display of the one or more impressions of the at least one advertisement.

20. A computer readable medium or media containing instructions for executing a method for use in association with an online advertising auction, the method comprising:
using one or more computers, obtaining a first set of information comprising bid data from a plurality of bidders for one or more serving opportunities for one or more advertisement slots, the bid data comprising one or more advertising bids from each of the bidders;
using one or more computers, obtaining a second set of information comprising a performance metric of the one or more serving opportunities in the one or more advertisement slots, wherein the performance metric is based on at least an expected click through rate;
using one or more computers, based on at least the first set of information and second set of information, generating allocation data for each of the one or more bidders that defines a number of serving opportunities that each of the bidders is allocated for each advertisement slot, wherein the allocation data is based on at least the performance metric of the serving opportunities in the advertisement slots; and
using one or more computers, based on at least the allocation data, allocating the serving opportunities to each of the bidders, comprising:
identifying a primary bidder from the plurality of bidders, the primary bidder being a bidder for which a highest bid was received;
identifying a primary advertising slot from the one or more advertisement slots, wherein the primary advertising slot is comprised of one or more primary serving opportunities and is based on at least the location of the slot with respect to one or more non-primary advertising slots;
allocating all of the primary serving opportunities in the primary advertising slot to the primary bidder; and
for a set of non-primary advertising slots, performing a non-linear allocation of one or more non-primary serving opportunities to one or more non-primary bidders, wherein the non-primary serving opportunities are allocated such that non-primary serving opportunities in each of the non-primary advertisement slots are not exclusively allocated to one of the non-primary bidders.
